(19) United States
(12) Patent Application Publication
(10) Pub. No.: US 2026/0356309 A1
(43) Pub. Date: Nov. 12, 2026

(54) SUPPORT PANEL ADJUSTMENT SYSTEM AND A VEHICLE INCLUDING THE SAME

(71) Applicants: HYUNDAI MOTOR COMPANY, Seoul (KR); KIA CORPORATION, Seoul (KR)

(72) Inventor: Guang You Dong, Yantai (CN)

(73) Assignees: HYUNDAI MOTOR COMPANY, Seoul (KR); KIA CORPORATION, Seoul (KR)

(21) Appl. No.: 19/323,159

(22) Filed: Sep. 9, 2025

(30) Foreign Application Priority Data
May 6, 2025 (CN) 202510581096.3

(51) Int. Cl. B60R 16/037; B60N 2/00; B60N 3/00; B60N 3/06; B60Q 9/00

(52) U.S. Cl. CPC B60R 16/037; B60N 2/0023; B60N 3/004; B60N 3/063; B60Q 9/00; B60N 2/0025; B60N 2210/40

(57) ABSTRACT

A support panel is installed on a back side of a backrest of a seat of a vehicle, and a support panel adjustment system includes a support panel driving device for driving and rotating the support panel so that the support panel is in either an unfolded state or a folded state, a vehicle interior monitoring device for detecting a state of a passenger in the vehicle, and a controller for controlling the support panel driving device to rotate the support panel based on the state of the passenger in the vehicle.

### CROSS REFERENCE TO RELATED APPLICATION

The present application claims priority to Chinese Patent Application No. 202510581096.3, filed May 6, 2025, the entire contents of which are incorporated herein for all purposes by this reference.

### BACKGROUND OF THE PRESENT DISCLOSURE

### Field of the Present Disclosure

The present disclosure relates to a support panel adjustment system and a vehicle including the same.

### Description of Related Art

FIG. 1 is a view illustrating an internal structure or configuration of a vehicle. As illustrated in FIG. 1, the vehicle is equipped with two seats located in the front row and two seats located in the back row. A tray is installed at an upper portion of a back side of a backrest of each front row seat, allowing passengers to place personal belongings thereon. A footrest is installed at a lower portion, enabling passengers to rest their feet and adjust their seating posture for enhanced riding comfort. In the vehicle illustrated in FIG. 1, the surface of an upper portion or surface of the tray is generally disposed along or parallel to a horizontal plane, allowing passengers to conveniently place items on the tray. Additionally, the surface of an upper portion of the footrest is also generally parallel to the horizontal plane, to allow passengers to comfortably rest their feet.

When a passenger in the front row adjusts the recline or angle of the backrest of a front row seat, the tray and footrest installed on the back side of the backrest also recline or change position with the backrest, moving away from their respective horizontal states. This may cause inconvenience for the passenger when placing items on the tray or resting his or her feet on the footrest.

FIG. 2 is a view illustrating the vehicle illustrated in FIG. 1, in which a tray is in a folded state and a passenger is holding an item with both hands. In such a state, since the passenger is holding an item with both hands, it is difficult to unfold the tray, which is problematic.

Another problem is that when the passenger passes over or by the tray and footrest that are in an unfolded state while entering and exiting the vehicle, the unfolded tray and footrest may interfere with the passenger's movement.

The foregoing is intended merely to enhance understanding of the background of the present disclosure. The presence of the foregoing information in the Description of the Related Art section is not intended as an acknowledgement that the foregoing information falls within the purview of the related art that is already known to those of ordinary skill in the art.

### SUMMARY

Accordingly, the present disclosure has been made keeping in mind the above problems occurring in the related art, and an objective of the present disclosure is to provide a support panel adjustment system that enables passengers to enter a vehicle comfortably, and a vehicle including the same.

In order to achieve the above objective, according to one aspect of the present disclosure, there is provided a support panel adjustment system, wherein the support panel may be installed on a back side of a backrest of a seat of a vehicle, the support panel adjustment system including: a support panel driving device configured to drive and rotate the support panel so that the support panel is in either an unfolded state or a folded state; a vehicle interior monitoring device configured to detect a state of a passenger in the vehicle; and a controller configured to control the support panel driving device to rotate the support panel based on the state of the passenger in the vehicle.

In the support panel adjustment system of the present disclosure, the support panel may be a tray, and the state of the passenger in the vehicle may include a state in which the passenger in the vehicle is holding an item in his or her hand, a state in which the passenger in the vehicle is not holding an item in his or her hands, a state in which the passenger in the vehicle intends to exit the vehicle, or a state in which the passenger in the vehicle does not intend to exit the vehicle.

In the support panel adjustment system of the present disclosure, based on it being detected by the vehicle interior monitoring device that the passenger in the vehicle is holding an item in his or her hand, the controller may cause the tray located in front of a seat on which the passenger in the vehicle is sitting to be in the unfolded state.

The support panel adjustment system of the present disclosure may further include: a speaker configured to output a phrase wherein the vehicle interior monitoring device may further detect whether there is an item on the tray, and based on it being detected by the vehicle interior monitoring device that the passenger in the vehicle intends to exit the vehicle and there is an item on the tray that the passenger in the vehicle passes while exiting the vehicle, the controller may cause the speaker to output the phrase which reminds a passenger in the vehicle to retrieve the item placed on the tray.

The support panel adjustment system of the present disclosure may further include: a vehicle exterior passenger sensor configured to detect a passenger outside the vehicle who intends to enter the vehicle; and a speaker configured to output a phrase, wherein the vehicle interior monitoring device may further detect whether there is an item on the tray, and based on it being detected by the vehicle interior monitoring device that there is an item on the tray that the passenger outside the vehicle passes while entering the vehicle, the controller may control the speaker to output the phrase that reminds a passenger in the vehicle to retrieve the item placed on the tray.

In the support panel adjustment system of the present disclosure, the support panel may be a footrest, the footrest may be installed on the back side of the seat of the vehicle, the state of the passenger in the vehicle may include that the passenger in the vehicle has continuously been in the vehicle for equal to or longer than a predetermined period of time or a state in which the passenger in the vehicle is in a fatigue state, and the controller may control the support panel driving device to rotate the footrest to the unfolded state based on the state of the passenger in the vehicle.

The support panel adjustment system of the present disclosure may further include: a speaker configured to output a phrase, wherein the vehicle monitoring device may further detect whether there are feet on the footrest, and based on it being detected by the vehicle interior monitoring device that the passenger in the vehicle intends to exit the vehicle and there being feet on the footrest that the passenger in the vehicle passes while exiting the vehicle, the controller may cause the speaker to output the phrase which reminds a passenger in the vehicle to remove his or her feet rested on the footrest.

The support panel adjustment system of the present disclosure may further include: a vehicle exterior passenger sensor configured to detect a passenger outside the vehicle who intends to enter the vehicle; and a speaker configured to output a phrase, wherein the vehicle monitoring device may further detect whether there are feet on the footrest, and based on it being detected by the vehicle interior monitoring device that there are feet on the footrest that the passenger outside the vehicle passes while entering the vehicle, the controller may control the speaker to output the phrase that reminds a passenger in the vehicle to remove his or her feet rested on the footrest.

The support panel adjustment system of the present disclosure may further include an angle sensor installed in the support panel, wherein the angle sensor may detect an angle formed between a surface of the support panel and a horizontal plane, and the controller may operate the support panel driving device to maintain the angle between the surface of the support panel and the horizontal plane at a predetermined angle.

According to another aspect of the present disclosure, there is provided a vehicle, including: a support panel installed on a back side of a backrest of a seat of the vehicle, the support panel adjustment system comprising: a support panel driving device configured to rotate the support panel so that the support panel is in either an unfolded state or a folded state; a vehicle interior monitoring device configured to detect a state of a passenger in the vehicle; and a controller configured to control the support panel driving device to rotate the support panel based on the state of the passenger in the vehicle.

The support panel may be a tray, and the state of the passenger in the vehicle may include a state in which the passenger in the vehicle is holding an item in his or her hand, a state in which the passenger in the vehicle is not holding an item in his or her hand, a state in which the passenger in the vehicle intends to exit the vehicle, or a state in which the passenger in the vehicle does not intend to exit the vehicle.

In the vehicle according to the present disclosure based on it being detected by the vehicle interior monitoring device that the passenger in the vehicle is holding an item in his or her hand, the controller causes the tray located in front of a seat on which the passenger in the vehicle is sitting to be in the unfolded state.

The support panel may be a footrest, the footrest may be installed on the back side of the seat of the vehicle, the state of the passenger in the vehicle may include a state in which the passenger in the vehicle has continuously been in the vehicle for equal to or longer than a predetermined period of time or a state in which the passenger in the vehicle is in a fatigue state, and the controller controls the support panel driving device to rotate the footrest to the unfolded state based on the state of the passenger in the vehicle.

The vehicle according to the present disclosure may further include a speaker configured to output a phrase. The vehicle monitoring device further detects whether there are feet on the footrest. Based on it being detected by the vehicle interior monitoring device that the passenger in the vehicle intends to exit the vehicle and there being feet on the footrest that the passenger in the vehicle passes while exiting the vehicle, the controller causes the speaker to output the phrase which reminds the passenger in the vehicle to remove his or her feet rested on the footrest.

Additionally, provided herein is a tray adjustment system, wherein the tray is installed on a back side of a backrest of a seat of a vehicle, the tray adjustment system comprising: a tray driving device configured to rotate the tray so that the tray is in either an unfolded state or a folded state; a vehicle interior monitoring device configured to detect a state of a passenger in the vehicle; and a controller configured to control the tray driving device to rotate the tray based on the state of the passenger in the vehicle.

The state of the passenger in the vehicle may include a state in which the passenger in the vehicle is holding an item in his or her hand, a state in which the passenger in the vehicle is not holding an item in his or her hand, a state in which the passenger in the vehicle intends to exit the vehicle, or a state in which the passenger in the vehicle does not intend to exit the vehicle.

According to the present disclosure, based on it being detected by the vehicle interior monitoring device that the passenger in the vehicle is holding an item in his or her hand, the controller causes the tray located in front of a seat on which the passenger in the vehicle is sitting to be in the unfolded state.

The tray adjustment system may further include a speaker configured to output a phrase, wherein the vehicle interior monitoring device further detects whether there is an item on the tray, and based on it being detected by the vehicle interior monitoring device that the passenger in the vehicle intends to exit the vehicle and there being an item on the tray that the passenger in the vehicle passes while exiting the vehicle, the controller causes the speaker to output the phrase, which reminds the passenger in the vehicle to retrieve the item placed on the tray.

The tray adjustment system may further include a vehicle exterior passenger sensor configured to detect a passenger outside the vehicle who intends to enter the vehicle; and a speaker configured to output a phrase, wherein the vehicle interior monitoring device further detects whether there is an item on the tray, and based on it being detected by the vehicle interior monitoring device that there is an item on the tray that the passenger outside the vehicle will have to pass while entering the vehicle, the controller controls the speaker to output the phrase, which reminds the passenger in the vehicle to retrieve the item placed on the tray.

According to the present disclosure the tray is installed on a back side of a backrest of a front row seat of the vehicle.

According to the present disclosure, it is possible to provide a support panel adjustment system that enables passengers to enter a vehicle comfortably, and a vehicle including the same.

### BRIEF DESCRIPTION OF THE DRAWINGS

The above and other objectives, features, and advantages of the present disclosure should be more clearly understood from the following detailed description when taken in conjunction with the accompanying drawings, in which:

FIG. 1 is a view illustrating the internal structure of a vehicle;

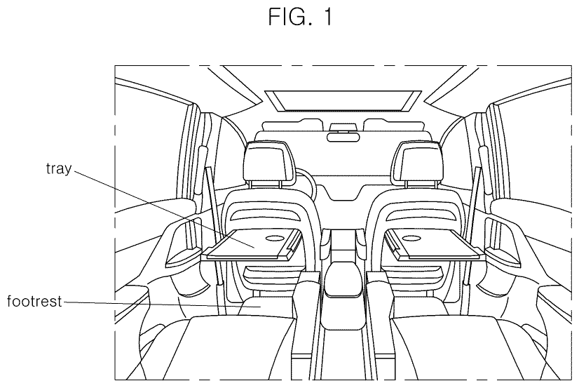

FIG. 2 is a view illustrating the vehicle illustrated in FIG. 1, in which a tray is in a folded state and a passenger is holding an item with both hands;

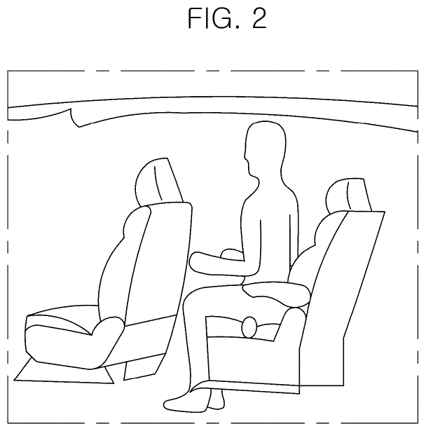

FIG. 3 is a view illustrating an arrangement of seats and shelves (an example of a support panel in the disclosure) of a vehicle according to a first embodiment;

FIG. 4 is a block diagram illustrating a structure of the vehicle according to the first embodiment;

FIG. 5 is a block diagram illustrating a structure of a support panel adjustment system (which may also be referred to as a “tray adjustment system”) according to the first embodiment;

FIG. 6 is a flowchart illustrating an example of rotating a tray from a folded state to an unfolded state;

FIG. 7 is a flowchart illustrating an example of rotating a tray from an unfolded state to a folded state when a passenger intends to exit a vehicle;

FIG. 8 is a flowchart illustrating an example of rotating a tray from an unfolded state to a folded state when a passenger intends to enter a vehicle;

FIG. 9 is a view illustrating an arrangement of seats and footrests (another example of a support panel in the disclosure) of a vehicle according to a second embodiment;

FIG. 10 is a block diagram illustrating a structure of the vehicle according to the second embodiment;

FIG. 11 is a block diagram illustrating a structure of a support panel adjustment system (which may also be referred to as a “footrest adjustment system”) according to the second embodiment;

FIG. 12 is a flowchart illustrating an example of rotating a footrest from a folded state to an unfolded state;

FIG. 13 is a flowchart illustrating an example of rotating a footrest from an unfolded state to a folded state when a passenger intends to exit a vehicle;

FIG. 14 is a flowchart illustrating an example of rotating a footrest from an unfolded state to a folded state when a passenger intends to enter a vehicle; and

FIG. 15 is a block diagram illustrating a structure of a vehicle according to a third embodiment.

### DETAILED DESCRIPTION

Hereinafter, several embodiments of the present disclosure are described. The following embodiments are provided solely for the purpose of illustrating the present disclosure. The present disclosure is not limited to the embodiments described herein.

Within a non-conflicting scope, one or more examples of a particular embodiment may be combined with one or more examples of another embodiment to derive yet another embodiment, which shall also be considered to fall within the scope of the present disclosure.

In the present specification, the same reference numerals are assigned to identical or similar structures, and redundant or duplicative descriptions of identical or similar structure has been omitted. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

### First Embodiment

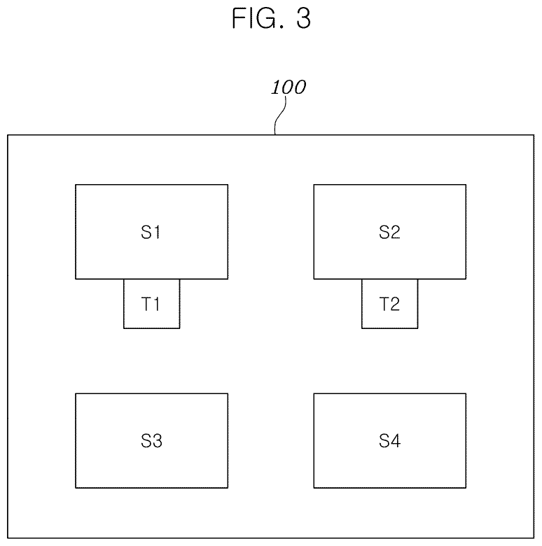

FIG. 3 is a view illustrating an arrangement of seats and shelves of a vehicle 100 according to the present embodiment. A shelf is an example of a support panel according to the present disclosure. As illustrated in FIG. 3, the vehicle 100 according to the present embodiment includes two rows of seats. The first row of seats include a seat S1 and a seat S2, and the second row of seats include a seat S3 located behind the seat S1 and a seat S4 located behind of the seat S2. A tray T1 is installed on a back side of a backrest of the seat S1, and a tray T2 is installed on a back side of a backrest of the seat S2. In the following description, the seats S1-S4 are sometimes collectively referred to as a seat S, and the trays T1 and T2 are sometimes collectively referred to as a tray T.

Additionally, the vehicle 100 may further include four doors, specifically, a left front door outside the seat S1, a right front door outside the seat S2, a left rear door outside the seat S3, and a right rear door outside the seat S4, although the doors are not illustrated in the specification.

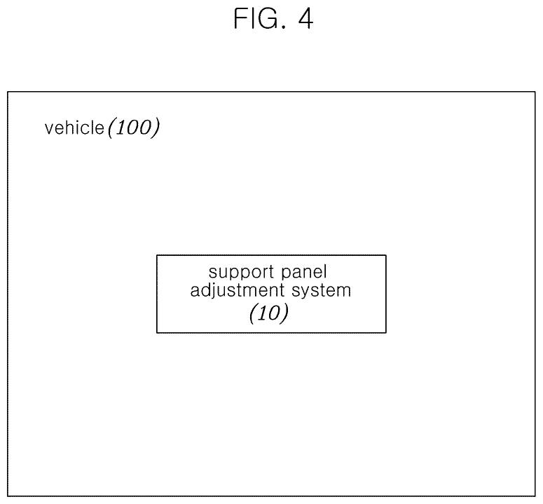

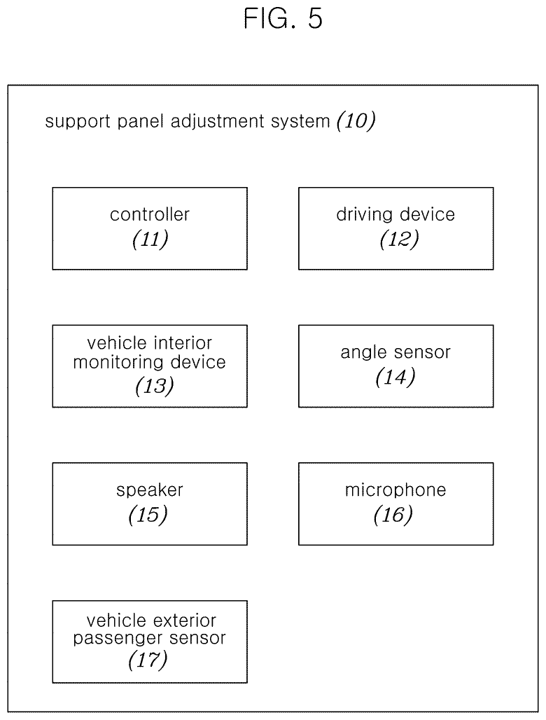

FIG. 4 is a block diagram illustrating a structure of a vehicle 100 according to the present embodiment. FIG. 5 is a block diagram illustrating the structure of a support panel adjustment system 10 (which may also be referred to as a “tray adjustment system”) according to the present embodiment.

The vehicle 100 includes the tray adjustment system 10. The tray adjustment system 10 is configured to adjust the state of the tray T, allowing the tray T to rotate around an axis to become or be disposed in either an unfolded state or a folded state. In the unfolded state, an upper surface (i.e., a surface on which an item may be placed) of the tray T forms or is disposed at a predetermined angle (e.g., 0 degrees) with respect to a horizontal plane, allowing a passenger to place an item on the tray T. In the folded state, the upper surface of the tray T is in close contact with the backrest of the seat (i.e., the upper surface of the tray faces forward and a lower surface thereof faces rearward), thereby widening or increasing the space between the front row and rear row seats to allow a passenger to get into or out of the seat. However, the present disclosure is not limited thereto. For example, in the folded state, the lower surface of the tray T may face forward and the upper surface thereof may face rearward.

The tray adjustment system 10 includes a controller 11, a driving device 12, a vehicle interior monitoring device 13, an angle sensor 14, a speaker 15, a microphone 16, and a vehicle exterior passenger sensor 17.

The controller 11 includes a central processing unit (CPU) and a storage unit (including read-only memory and random access memory, etc.). The storage unit includes a control program for controlling the operation of one or more parts (e.g., each part) included in the tray adjustment system 10. The CPU loads and executes a control program stored in the storage unit (e.g., memory), thereby enabling the overall system to function as the tray adjustment system according to the present disclosure.

The driving device 12 is a tray driving device (an example of a support panel driving device in the disclosure) and includes a motor (e.g., an electric motor) built into the tray T. Under the control of the controller 11, the driving device 12 causes the tray T to rotate between the unfolded state and the folded state. The motor is not limited to being built into the tray T, but may also be installed on the backrest of the seat.

The vehicle interior monitoring device 13 includes a weight sensor installed in the seat S, and detects whether a passenger on the seat S intends to exit the vehicle using the weight sensor. For example, the weight sensor detects the weight of the passenger on the seat S and transmits the detected weight value of the passenger to the controller 11. The controller 11 determines that the passenger intends to exit the vehicle when the passenger's weight value transmitted from the weight sensor is 0.

The vehicle interior monitoring device 13 further includes at least one selected from a camera, an infrared sensor, a LiDAR, or an ultrasonic sensor installed on an upper portion (e.g., ceiling) of the interior of the vehicle 100. The camera, the infrared sensor, the LiDAR, and the ultrasonic sensor may employ conventional structures known in the art. The vehicle interior monitoring device 13 detects whether a passenger in the vehicle is holding an item in his or her hand (specifically, e.g., with both hands) or whether there is an item on the tray T.

For example, a plurality of models are stored in the storage unit of the controller 11, the plurality of models including a model in which an item is held in the passenger's hand, a model in which no item is held in the passenger's hand, a model in which an item is placed on the tray T, and a model in which no item is placed on the tray T. These models collectively constitute a model library. The controller 11 compares data transmitted from the vehicle interior monitoring device 13 with each model in the model library to identify the model that most closely matches the data transmitted from the vehicle interior monitoring device 13, thereby determining whether the passenger is holding an item in his or her hand or whether there is an item on the tray T. For example, when the model that most closely matches the data of the vehicle interior monitoring device 13 is identified to be the model in which an item is placed on the tray T, it is determined that there is an item on the tray T.

The angle sensor 14 is built into the tray T, and detects the angle formed between the upper surface (item placement surface) of the tray T and the horizontal plane and transmits the detected value to the controller 11. The controller 11 determines whether the tray T is in the unfolded state or the folded state based on the detected value transmitted from the angle sensor 14. In the unfolded state, the upper surface of the tray T and the horizontal plane form a predetermined angle (e.g., 0 degrees). The predetermined angle may be a single value (e.g., 0 degrees) or a range of values (e.g., 0 to 5 degrees). In the folded state, the angle between the upper surface of the tray T and the horizontal plane is usually equal to or greater than 60 degrees.

The speaker 15 is installed at a predetermined location on the vehicle ceiling, and outputs a predetermined voice or phrase under the control of the controller 11. The predetermined voice includes a voice that reminds a passenger in the vehicle to retrieve an item placed on the tray T. For example, based on the detection data transmitted from the vehicle interior monitoring device 13, when it is determined that the passenger on the seat S3 intends to exit the vehicle and there is an item on the tray T2 in front of (i.e., on the back side of the backrest of the seat S2) the seat S4 that the passenger passes while exiting the vehicle, the controller 11 instructs the speaker 15 to output a voice such as “Please retrieve your item from the tray. The tray will fold soon”.

The microphone 16 is installed at a different predetermined location on the vehicle ceiling, and collects voice information from a passenger and transmits it to the controller 11. For example, when the passenger on the seat S3 intends to fold the tray T1 in front, the passenger utters a phrase, keyword, or command such as “Please fold the tray” in addition to manually folding the tray T1. After receiving or sensing the key phrase “Please fold the tray”, the microphone 16 transmits information indicating the voice to the controller 11. The controller 11 operates the driving device 12 in response to the voice information to rotate the tray T1 and thereby fold the tray T1.

The vehicle exterior passenger sensor 17 detects passengers outside vehicle who intend to get into the seats S3 and S4. The vehicle exterior passenger sensor 17 further includes at least one selected from a camera, an infrared sensor, LiDAR, and an ultrasonic sensor. The vehicle exterior passenger sensor 17 may be installed, for example, on the exterior of the vehicle, specifically, on an upper portion of the exterior of the vehicle or in a casing or housing of an exterior rearview mirror located on the outside of each of the seats S1 and S2. The camera, the infrared sensor, the LiDAR, and the ultrasonic sensor may employ conventional structures known in the related art, and detects whether there are passengers outside the vehicle intending to enter the vehicle.

The vehicle exterior passenger sensor 17 may further include a door open/close (e.g., door position) sensor for detecting the opening/closing of doors on both sides of the seats S3 and S4. When it is detected that the doors are opened from the outside based on a detection signal transmitted from the door open/close sensor, it is determined that there are passengers outside the vehicle who intend to get into the seats S3 and S4.

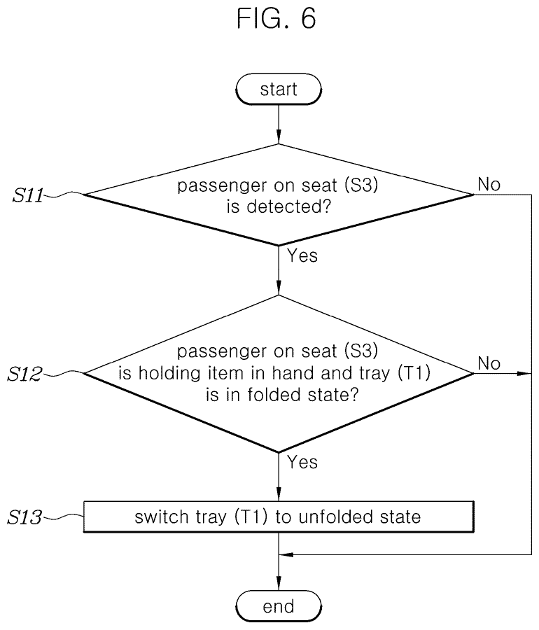

FIG. 6 is a flowchart illustrating an example of rotating a tray T1 from a folded state to an unfolded state.

First, in step S11, the controller 11 determines whether there is a passenger on the seat S3 based on information transmitted from the vehicle interior monitoring device 13. When it is determined that there is no passenger on the seat S3, this process is terminated. At this time, the information of the vehicle interior monitoring device 13 may be detection information transmitted from the weight sensor in the seat S3, or may be detection information of at least one selected from a camera, an infrared sensor, LiDAR, and an ultrasonic sensor (e.g., disposed within the passenger compartment).

In step S11, when the controller 11 determines that there is a passenger on the seat S3, step S12 is entered or performed. In step S12, the controller 11 determines whether the passenger on the seat S3 is holding an item in his or her hand and whether the tray T1 is in the folded state based on information transmitted from the vehicle interior monitoring device 13. When the passenger on the seat S3 is not holding an item and/or the tray T1 is in the unfolded state, this process is terminated. At this time, the information of the vehicle interior monitoring device 13 may be detection information of at least one selected from a camera, an infrared sensor, LiDAR, and an ultrasonic sensor.

In step S12, when the controller 11 determines that the passenger on the seat S3 is holding an item in his or her hand and the tray T1 is in the folded state, step S13 is entered. In step S13, the controller 11 controls the tray driving device 12 to rotate the tray T1 to the unfolded state, allowing the passenger to place the item held in his or her hand on the tray T1. Subsequently, this process is terminated.

The present disclosure is not limited to the process illustrated in FIG. 6. For example, steps S11 and S12 may be combined into a single step. Additionally, step S12 may be divided into two steps, i.e., in one of the two steps, it is determined whether the passenger on the seat is holding an item in his or her hand, and in the other step, it is determined whether the tray is in the folded state.

As described above, the support panel adjustment system 10 according to the present disclosure allows the tray to be automatically unfolded when the passenger is holding an item in his or her hand and thus is unable to unfold the tray manually. This enables the passenger to place the item on the tray conveniently, and enhances the overall luxury of the vehicle 100 equipped with the support panel adjustment system 10.

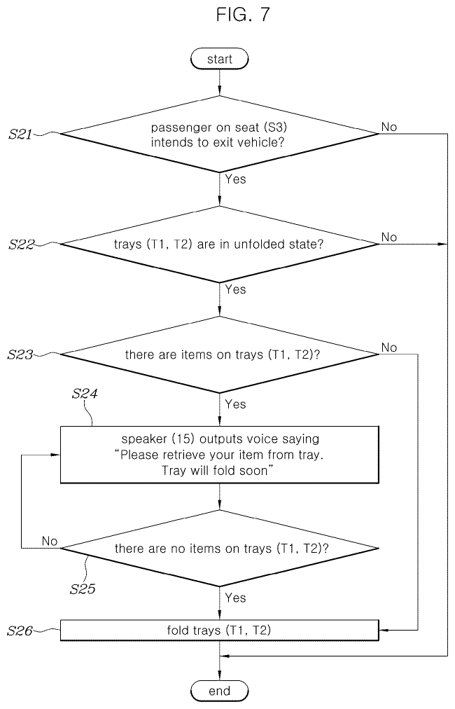

FIG. 7 is a flowchart illustrating an example of rotating a tray from an unfolded state to a folded state when a passenger intends to exit a vehicle.

First, in step S21, the controller 11 determines whether the passenger on the seat S3 intends to exit the vehicle based on information transmitted from the vehicle interior monitoring device 13. When it is determined that the passenger on the seat S3 does not intend to exit the vehicle, this process is terminated. At this time, the information of the vehicle interior monitoring device 13 may be detection information transmitted from the weight sensor in the seat S3, or may be detection information of at least one selected from a camera, an infrared sensor, LiDAR, and an ultrasonic sensor (e.g., disposed in the passenger compartment).

In step S21, when the controller 11 determines that the passenger on the seat S3 intends to exit the vehicle, step S22 is entered. In step S22, the controller 11 determines whether the trays T1 and T2 are in the unfolded state based on detection information of the angle sensor 14 or information transmitted from the vehicle interior monitoring device 13. In step S22, when it is determined that the trays T1 and T2 are in the folded state rather than the unfolded state, this process is terminated.

In step S22, when the controller 11 determines that the trays T1 and T2 are in the unfolded state, step S23 is entered. In step S23, the controller 11 determines whether there are items on the trays T1 and T2 based on information transmitted from the vehicle interior monitoring device 13. In step S23, when it is determined that there are no items on the trays T1 and T2, the process moves to step S26, which is described hereinafter. At this time, the information of the vehicle interior monitoring device 13 may be detection information of at least one selected from a camera, an infrared sensor, LiDAR, and an ultrasonic sensor.

In step S23, when the controller 11 determines that there are items on the trays T1 and T2, step S24 is entered. In step S24, the controller 11 instructs the speaker 15 to output a voice or phrase saying, “Please retrieve your item from the tray. The tray will fold soon”, thereby notifying both the passenger himself or herself and a passenger on the seat S4 to retrieve the items from the trays T1 and T2. Subsequently, step S25 is entered.

In step S25, the controller 11 determines whether there are no items on the trays T1 and T2 based on information transmitted from the vehicle interior monitoring device 13. In step S25, when it is determined that there are items on the trays T1 and T2, the process returns to step S24.

In step S25, when it is determined that there are no items on the trays T1 and T2, the process moves to step S26. In step S26, the controller 11 controls the tray driving device 12 to rotate the trays T1 and T2 to the folded state. Subsequently, this process is terminated.

As described above, the support panel adjustment system 10 according to the present disclosure allows the tray to be automatically folded when the passenger intends to exit the vehicle, thereby widening or increasing the space between the front and rear rows of seats. This enables the passenger to exit the vehicle easily, and enhances the overall luxury of the vehicle 100 equipped with the support panel adjustment system 10.

In the process illustrated in FIG. 7, it has been described that intention of the passenger on the seat S3 to exit the vehicle is detected, but the present disclosure is not limited thereto. For example, intention of the passenger on the seat S4 to exit the vehicle may also be detected. When it is detected that the passenger on the seat S4 intends to exit the vehicle and there is an item on the tray T2, the speaker 15 may output a voice or phrase saying, “please retrieve your item from the tray. The tray will fold soon”, thereby notifying the passenger on the seat S4 to retrieve the item from the tray T2. Next, when it is determined that there is no item on the tray T2, the tray T2 is rotated to the folded state.

In the above manner, when the passenger intends to exit the vehicle, the tray is allowed to be automatically folded to widen or increase the space between the front and rear rows of seats. This enables the passenger to exit the vehicle easily, and enhances the overall luxury of the vehicle 100 equipped with the support panel adjustment system 10.

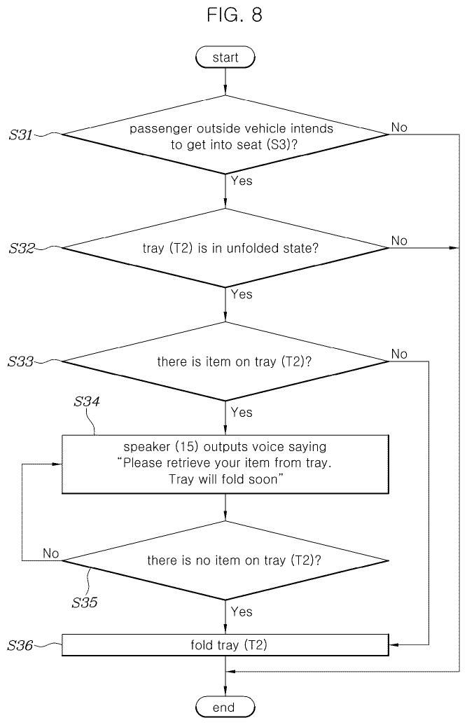

FIG. 8 is a flowchart illustrating an example of rotating a tray from an unfolded state to a folded state when a passenger intends to enter a vehicle. In this process, it is assumed that there is a passenger outside the vehicle who intends to enter the vehicle and there is a passenger who is currently sitting on the seat S4, so the external passenger needs to pass through the seat S4 to reach the seat S3.

First, in step S31, the controller 11 determines whether there is a passenger who intends to move to the seat S3 based on information transmitted from the vehicle interior monitoring device 13. When it is determined that there is no passenger who intends to move to the seat S3, this process is terminated.

In step S31, when the controller 11 determines that there is a passenger outside the vehicle who intends to move to the seat S3, step S32 is entered. In step S32, the controller 11 determines whether the tray T2 is in the unfolded state based on detection information of the angle sensor 14 or information transmitted from the vehicle interior monitoring device 13. In step S32, when it is determined that the tray T2 is in the folded state rather than the unfolded state, this process is terminated.

In step S32, when the controller 11 determines that the tray T2 is in the unfolded state, step S33 is entered. In step S33, the controller 11 determines whether there is an item on the tray T2 based on information transmitted from the vehicle interior monitoring device 13. In step S33, when it is determined that there is no item on the tray T2, the process moves to step S36, which is described hereinafter.

In step S33, when the controller 11 determines that there is an item on the tray T2, step S34 is entered. In step S34, the controller 11 instructs the speaker 15 to output a voice or phrase saying, “Please retrieve your item from the tray. The tray will fold soon”, thereby notifying the passenger on the seat S4 to retrieve the item from the tray T2. Subsequently, step S35 is entered.

In step S35, the controller 11 determines whether there is no item on the tray T2 based on information transmitted from the vehicle interior monitoring device 13. In step S35, when it is determined that there is an item on the tray T2, the process returns to step S34.

In step S35, when it is determined that there is no item on the tray T2, the process moves to step S36. In step S36, the controller 11 controls the tray driving device 12 to rotate the tray T2 to the folded state. Subsequently, this process is terminated.

As described above, the support panel adjustment system 10 according to the present disclosure allows the tray to be automatically folded when the passenger intends to enter the vehicle and needs to pass through the seat S4, thereby widening the space between the front and rear rows of seats. This enables the passenger to enter the vehicle easily, and enhances the overall luxury of the vehicle 100 equipped with the support panel adjustment system 10.

As described above, the angle sensor 14 is installed in the tray T. Using the angle sensor 14, the angle formed between the upper surface (item placement surface) of the tray T and the horizontal plane is detected. When the angle between the upper surface of the tray T and the horizontal plane deviates from a predetermined angle due to a change in recline angle of the backrests of the front row seats 1 and 2, the controller 11 operates the driving device 12 to rotate the tray T, thereby adjusting the angle between the upper surface of the tray T and the horizontal plane back to the predetermined angle.

Additionally, the term “tray” used in this specification is not limited to a narrowly defined plate-like structure for placing objects, but encompasses all structures capable of placing objects and rotating between the unfolded state and the folded state. For example, a frame, etc. that can place objects and rotate between the unfolded state and the folded state is also within the scope of the term “tray” as defined and used herein.

### Second Embodiment

Hereinafter, another embodiment is described. The main difference between the second embodiment and the first embodiment is that a vehicle 100A of the second embodiment includes a footrest F and a support panel adjustment system 20. Hereinafter, a description is provided focusing on the differences between the two embodiments. In the present specification, the same reference numerals are assigned to structures that are identical or correspond to those in the first embodiment, and redundant descriptions may be omitted.

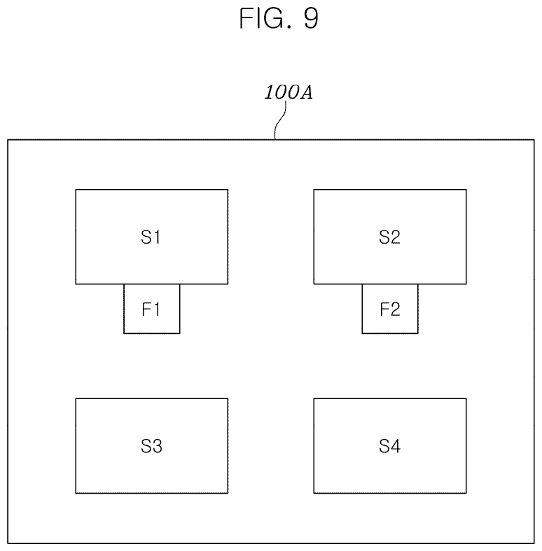

FIG. 9 is a view illustrating the arrangement of seats and footrests (another example of a support panel according to the disclosure) of the vehicle 100A according to the present embodiment. As illustrated in FIG. 9, a footrest F1 is installed on a back side of a backrest of a seat S1, and a footrest F2 is installed on a back side of a backrest of a seat S2. In the following description, the footrests F1 and F2 are sometimes collectively referred to as a footrest F.

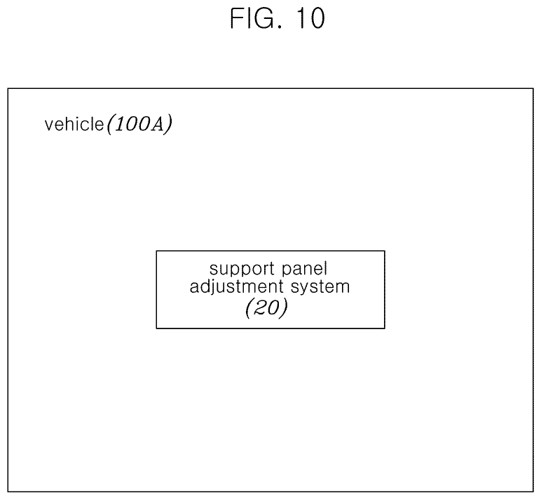

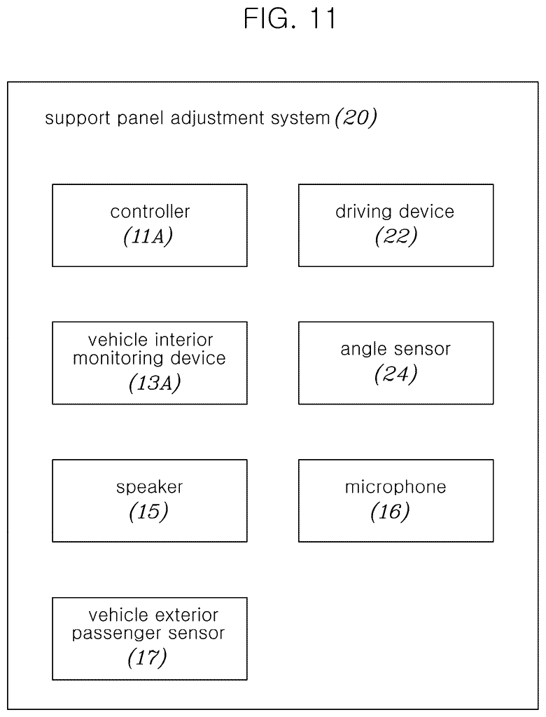

FIG. 10 is a block diagram illustrating the structure of the vehicle 100A according to the present embodiment. FIG. 11 is a block diagram illustrating the structure of the support panel adjustment system 20 according to the present embodiment.

The vehicle 100A includes the support panel adjustment system 20 (which may also be referred to as a footrest adjustment system). The support panel adjustment system 20 is configured to adjust the state of the footrest F, allowing the footrest F to rotate around an axis to become in either an unfolded state or a folded state. In the unfolded state, an upper surface (i.e., a foot resting surface) of the footrest F forms a predetermined angle (e.g., 0 degrees or greater) with respect to the horizontal plane, allowing a passenger to rest his or her feet on the footrest F. In the folded state, the upper surface of the footrest F is in close contact with the backrest of the seat (i.e., the upper surface of the footrest faces forward and a lower surface thereof faces rearward), thereby widening the space between the front row and rear row seats to allow a passenger to get into or out of the seat. However, the present disclosure is not limited thereto. For example, in the folded state, the lower surface of the footrest T may face forward and the upper surface thereof may face rearward.

The support panel adjustment system 20 includes a controller 11A, a driving device 22, a vehicle interior monitoring device 13A, an angle sensor 24, a speaker 15, a microphone 16, and a vehicle exterior passenger sensor 17.

The controller 11A includes a CPU (e.g., a processor) and a storage unit (e.g., memory). The storage unit includes a control program for controlling the operation of one or more parts (e.g., each) part included in the support panel adjustment system 20. The CPU loads and executes a control program stored in the storage unit (e.g., memory), thereby enabling the overall system to function as the support panel adjustment system according to the present disclosure.

The driving device 22 is a footrest driving device (an example of a support panel driving device in the disclosure) and includes a motor (e.g., electric motor) built into the footrest F. Under the control of the controller 11A, the driving device 22 causes the footrest F to rotate between the unfolded state and the folded state. The motor is not limited to being built into the footrest F, but may also be installed on the backrest of the seat.

The vehicle interior monitoring device 13A includes a weight sensor installed in the seat S, and detects whether a passenger on the seat S intends to exit the vehicle using the weight sensor. The vehicle interior monitoring device 13A further includes at least one selected from a camera, an infrared sensor, a LiDAR, and an ultrasonic sensor installed on an upper portion (e.g., ceiling) of the interior of the vehicle 100A. The camera, the infrared sensor, the LiDAR, and the ultrasonic sensor may employ conventional structures known in the art. The vehicle interior monitoring device 13A detects whether a passenger in the vehicle is holding an item in his or her hand (specifically, e.g., with both hands) or there are feet on the footrest F.

For example, a plurality of models are stored in the storage unit of the controller 11A, the plurality of models including a model in which an item is held in the passenger's hand, a model in which no item is held in the passenger's hand, a model in which feet are on the footrest F, and a model in which no feet are on the footrest F. These models collectively constitute a model library. The controller 11A compares data transmitted from the vehicle interior monitoring device 13A with each model in the model library to identify the model that most closely matches the data transmitted from the vehicle interior monitoring device 13A, thereby determining whether the passenger is holding an item in his or her hand or there are feet on the footrest F. For example, when the model that most closely matches the data of the vehicle interior monitoring device 13A is identified to be the model in which feet are on the footrest F, it may be determined that there are feet on the footrest F.

The angle sensor 24 is built into the footrest F, and detects the angle formed between the upper surface (foot resting surface) of the footrest F and the horizontal plane and transmits the detected value to the controller 11A. The controller 11A determines whether the footrest F is in the unfolded state or the folded state based on the detected value transmitted from the angle sensor 24. In the unfolded state, the upper surface of the footrest F and the horizontal plane form a predetermined angle (e.g., 0 degrees). The predetermined angle may be a single value (e.g., 0 degrees) or a range of values (e.g., 0−20 degrees). In the folded state, the angle between the upper surface of the footrest F and the horizontal plane is usually equal to or greater than 60 degrees.

The speaker 15 is installed at a predetermined location on the vehicle ceiling, and outputs a predetermined voice or phrase under the control of the controller 11A. The predetermined voice includes a voice that reminds a passenger in the vehicle to remove his or her feet rested on the footrest F. For example, based on the detection data transmitted from the vehicle interior monitoring device 13A, when it is determined that a passenger on a seat S3 intends to exit the vehicle and there are feet on the footrest F2 in front of (i.e., on the back side of the backrest of the seat S2) a seat S4 that the passenger passes while exiting the vehicle, the controller 11A instructs the speaker 15 to output a voice or phrase such as “Please remove your feet from the footrest. The footrest will fold soon”.

The microphone 16 is installed at a different predetermined location on the vehicle ceiling, and collects or senses voice information from a passenger and transmits it to the controller 11A. For example, when the passenger on the seat S3 intends to fold the footrest F1 in front, the passenger utters a voice or phrase such as “Please fold the footrest” in addition to folding the footrest F1 with his or her foot. After receiving the voice “Please fold the footrest”, the microphone 16 transmits information indicating the voice or phrase to the controller 11A. The controller 11A operates the driving device 22 in response to the voice information to rotate the footrest F1 and thereby fold the footrest F1.

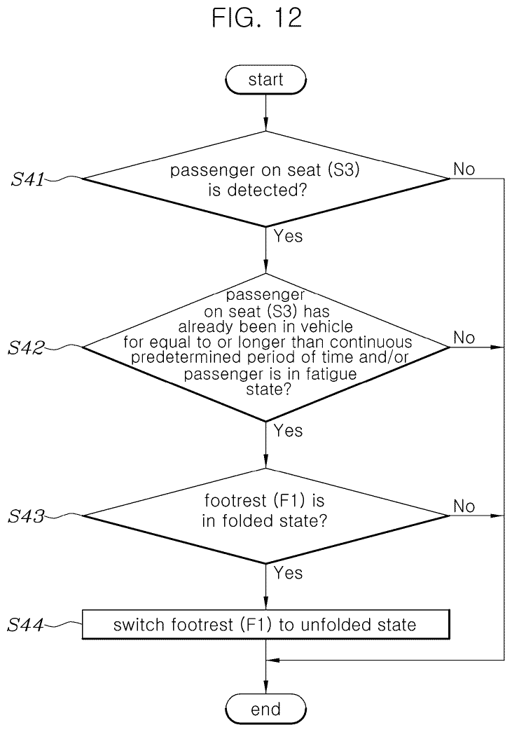

FIG. 12 is a flowchart illustrating an example of rotating a footrest F1 from a folded state to an unfolded state.

First, in step S41, the controller 11A determines whether there is a passenger on the seat S3 based on information transmitted from the vehicle interior monitoring device 13A. When it is determined that there is no passenger on the seat S3, this process is terminated. At this time, the information of the vehicle interior monitoring device 13A may be detection information transmitted from the weight sensor in the seat S3, or may be detection information of at least one selected from a camera, an infrared sensor, LiDAR, and an ultrasonic sensor.

In step S41, when the controller 11A determines that there is a passenger on the seat S3, step S42 is entered. In step S42, the controller 11A determines whether the passenger on the seat S3 has already been in the vehicle for equal to or longer than a continuous predetermined period of time (e.g., 1 hour) and/or whether the passenger is in a fatigue state based on information transmitted from the vehicle interior monitoring device 13A. At this time, the fatigue state includes whether the passenger's body has maintained the same posture for equal to or longer than a continuous predetermined period of time (e.g., 10 minutes), whether the passenger's movements have slowed down, or whether the passenger's face have showed signs of fatigue. When the passenger has already been in the vehicle for equal to or longer than the continuous predetermined period of time, it is determined that the passenger is in the fatigue state.

When it is determined that the passenger on the seat S3 has not been in the vehicle for equal to or longer than the continuous predetermined period of time and is not in the fatigue state, this process is terminated.

In step S42, when the controller 11A determines that the passenger on the seat S3 has already been in the vehicle for equal to or longer than the continuous predetermined period of time and/or that the passenger is in the fatigue state, step S43 is entered. In step S43, the controller 11A determines whether the footrest F1 is in the folded state based on detection information of the angle sensor 24 or information transmitted from the vehicle interior monitoring device 13A. In step S43, when it is determined that the footrest F1 is in the unfolded state rather than the folded state, this process is terminated.

In step S43, when the controller 11A determines that the footrest F1 is in the folded state, step S44 is entered, and the controller 11A controls the footrest driving device 22 to rotate the footrest F1 to the unfolded state, allowing the passenger to rest his or her feet on the footrest F1. Subsequently, this process is terminated.

As described above, the support panel adjustment system 20 according to the present disclosure allows the footrest to be automatically unfolded when the passenger has been in the vehicle for equal to or longer than the continuous predetermined period of time and/or the passenger is in the fatigue state. This enables the passenger to relieve fatigue in a more comfortable posture by resting his or her feet on the footrest, and enhances the overall luxury of the vehicle 100A equipped with the support panel adjustment system 20.

In the process illustrated in FIG. 12, it has been described that step S42 is performed before step S43, but the present disclosure is not limited thereto. For example, step S43 may be performed before step S42.

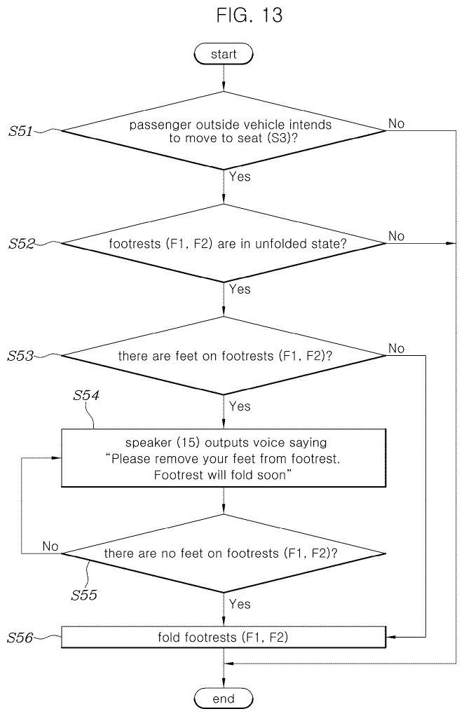

FIG. 13 is a flowchart illustrating an example of rotating a footrest from an unfolded state to a folded state when a passenger intends to exit a vehicle.

First, in step S51, the controller 11A determines whether the passenger on the seat S3 intends to exit the vehicle based on information transmitted from the vehicle interior monitoring device 13A. When it is determined that the passenger on the seat S3 does not intend to exit the vehicle, this process is terminated. At this time, the information of the vehicle interior monitoring device 13A may be detection information transmitted from the weight sensor in the seat S3, or may be detection information of at least one selected from a camera, an infrared sensor, LiDAR, and an ultrasonic sensor.

In step S51, when the controller 11A determines that the passenger on the seat S3 intends to exit the vehicle, step S52 is entered. In step S52, the controller 11A determines whether the footrests F1 and F2 are in the unfolded state based on detection information of the angle sensor 24 or information transmitted from the vehicle interior monitoring device 13A. In step S52, when it is determined that the footrests F1 and F2 are in the folded state rather than the unfolded state, this process is terminated.

In step S52, when the controller 11A determines that the footrests F1 and F2 are in the unfolded state, step S53 is entered. In step S53, the controller 11A determines whether there are feet on the footrests F1 and F2 based on information transmitted from the vehicle interior monitoring device 13A. In step S53, when it is determined that there are no feet on the footrests F1 and F2, the process moves to step S56, which is described hereinafter. At this time, the information of the vehicle interior monitoring device 13A may be detection information of at least one selected from a camera, an infrared sensor, LiDAR, and an ultrasonic sensor.

In step S53, when the controller 11A determines that there are feet on the footrests F1 and F2, step S54 is entered. In step S54, the controller 11A instructs the speaker 15 to output a voice or phrase saying, “Please remove your feet from the footrest. The footrest will fold soon”, thereby notifying the passenger himself or herself and a passenger on the seat S4 to remove his or her feet rested on the footrests F1 and F2. Subsequently, step S55 is entered.

In step S55, the controller 11A determines whether there are no feet on the footrests F1 and F2 based on information transmitted from the vehicle interior monitoring device 13A. In step S55, when it is determined that there are feet on the footrests F1 and F2, the process returns to step S54.

In step S55, when it is determined that there are no feet on the footrests F1 and F2, the process moves to step S56. In step S56, the controller 11A controls the footrest driving device 22 to rotate the footrests F1 and F2 to the folded state. Subsequently, this process is terminated.

As described above, the support panel adjustment system 20 according to the present disclosure allows the footrest to be automatically folded when the passenger intends to exit the vehicle, thereby widening the space between the front and rear rows of seats. This enables the passenger to exit the vehicle easily, and enhances the overall luxury of the vehicle 100A equipped with the support panel adjustment system 20.

In the process illustrated in FIG. 13, it has been described that intention of the passenger on the seat S3 to exit the vehicle is detected, but the present disclosure is not limited thereto. For example, intention of the passenger on the seat S4 to exit the vehicle may also be detected. When it is detected that the passenger on the seat S4 intends to exit the vehicle and the footrest F2 is in the unfolded state, the footrest F2 rotates to the folded state.

In the above manner, when the passenger intends to exit the vehicle, the footrest is allowed to be automatically folded to widen or increase the space between the front and rear rows of seats. This enables the passenger to exit the vehicle easily, and enhances the overall luxury of the vehicle 100A equipped with the support panel adjustment system 20.

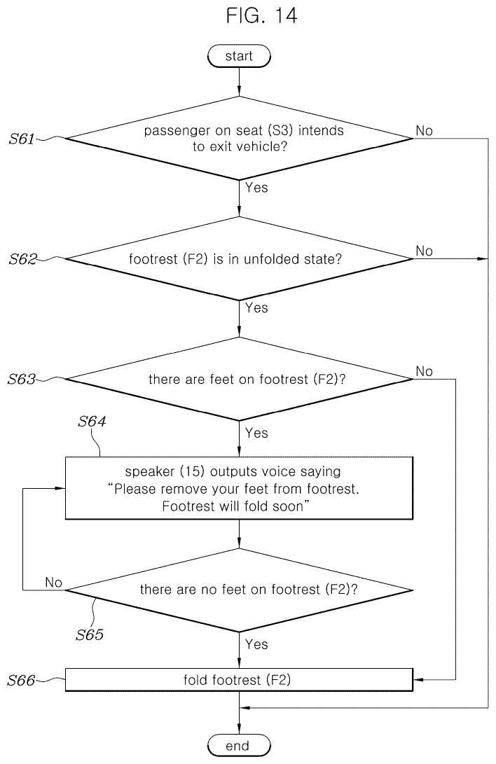

FIG. 14 is a flowchart illustrating an example of rotating a footrest from an unfolded state to a folded state when a passenger intends to enter a vehicle. In this process, it is assumed that there is a passenger outside the vehicle who intends to enter the vehicle and there is a passenger who has sit on the seat S4, so the external passenger needs to pass through or by the seat S4 to reach the seat S3.

First, in step S61, the controller 11A determines whether there is a passenger who intends to move to the seat S3 based on information transmitted from the vehicle interior monitoring device 13. When it is determined that there is no passenger who intends to move to the seat S3, this process is terminated.

In step S61, when the controller 11A determines that there is a passenger outside the vehicle who intends to move to the seat S3, step S62 is entered. In step S62, the controller 11A determines whether the footrest F2 is in the unfolded state based on detection information of the angle sensor 24 or information transmitted from the vehicle interior monitoring device 13A. In step S62, when it is determined that the footrest F2 is in the folded state rather than the unfolded state, this process is terminated.

In step S62, when the controller 11A determines that the footrest F2 is in the unfolded state, step S63 is entered. In step S63, the controller 11A determines whether there are feet on the footrest F2 based on information transmitted from the vehicle interior monitoring device 13A. In step S63, when it is determined that there are no feet on the footrest F2, the process moves to step S66, which is described hereinafter.

In step S63, when the controller 11A determines that there are feet on the footrest F2, step S64 is entered. In step S64, the controller 11A instructs the speaker 15 to output a voice or phrase saying, “Please remove your feet from the footrest. The footrest will fold soon”, thereby notifying the passenger on the seat S4 to remove his or her feet rested on the footrest F2. Subsequently, step S65 is entered.

In step S65, the controller 11A determines whether there are no feet on the footrest F2 based on information transmitted from the vehicle interior monitoring device 13A. In step S65, when it is determined that there are feet on the footrest F2, the process returns to step S64.

In step S65, when it is determined that there are no feet on the footrest F2, the process moves to step S66. In step S66, the controller 11A controls the footrest driving device 22 to rotate the footrest F2 to the folded state. Subsequently, this process is terminated.

As described above, the support panel adjustment system 20 according to the present disclosure allows the footrest to be automatically folded when the passenger intends to enter the vehicle and needs to pass through the seat S4, thereby widening or increasing the space between the front and rear rows of seats. This enables the passenger to enter the vehicle easily, and enhances the overall luxury of the vehicle 100A equipped with the support panel adjustment system 20.

As described above, the angle sensor 24 is installed in the footrest F. Using the angle sensor 24, the angle formed between the upper surface (foot resting surface) of the footrest F and the horizontal plane is detected. When the angle between the upper surface of the footrest F and the horizontal plane deviates from a predetermined angle due to a change in recline angle of the backrests of the front row seats 1 and 2, the controller 11A operates the driving device 22 to rotate the footrest F, thereby adjusting the angle between the upper surface of the footrest F and the horizontal plane back to the predetermined angle.

Additionally, the term “footrest” used in this specification is not limited to a narrowly defined plate-like structure for resting feet, but encompasses all structures capable of resting feet and rotating between the unfolded state and the folded state. For example, a frame, etc. that can rest feet and rotate between the unfolded state and the folded state is also within the scope of the term “footrest” as defined and used herein.

### Third Embodiment

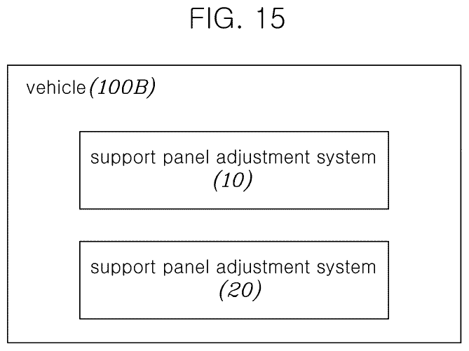

FIG. 15 is a block diagram illustrating the structure of a vehicle 100B according to the present embodiment. As illustrated in FIG. 15, the vehicle 100B according to the present embodiment includes a support panel adjustment system 10 and a footrest adjustment system 20. In the vehicle 100B of the present disclosure, a tray T is installed on an upper portion of a back side of a backrest of a seat of the vehicle, and a footrest F is installed on a lower portion of the back side of the backrest of the seat of the vehicle.

According to the present embodiment, in addition to achieving the effects of the first embodiment, the effects of the second embodiment can also be achieved.

In the present specification, the present disclosure has been described with reference to a vehicle having two rows of seats, but is not limited thereto. The vehicle of the present disclosure may also be applied to a vehicle equipped with three or more rows of seats.

In the present specification, the terms “first”, “second”, etc. are used merely for descriptive purposes and should not be construed as specifying relative importance or implying any particular order of technical features.

What is claimed is:

1. A support panel adjustment system, wherein the support panel is installed on a back side of a backrest of a seat of a vehicle, the support panel adjustment system comprising:
a support panel driving device configured to rotate the support panel so that the support panel is in either an unfolded state or a folded state;
a vehicle interior monitoring device configured to detect a state of a passenger in the vehicle; and
a controller configured to control the support panel driving device to rotate the support panel based on the state of the passenger in the vehicle.

2. The support panel adjustment system of claim 1, wherein the support panel is a tray, and
the state of the passenger in the vehicle includes a state in which the passenger in the vehicle is holding an item in his or her hand, a state in which the passenger in the vehicle is not holding an item in his or her hand, a state in which the passenger in the vehicle intends to exit the vehicle, or a state in which the passenger in the vehicle does not intend to exit the vehicle.

3. The support panel adjustment system of claim 2, wherein based on it being detected by the vehicle interior monitoring device that the passenger in the vehicle is holding an item in his or her hand, the controller causes the tray located in front of a seat on which the passenger in the vehicle is sitting to be in the unfolded state.

4. The support panel adjustment system of claim 2, further comprising:
a speaker configured to output a phrase,
wherein the vehicle interior monitoring device further detects whether there is an item on the tray, and
based on it being detected by the vehicle interior monitoring device that the passenger in the vehicle intends to exit the vehicle and there being an item on the tray that the passenger in the vehicle passes while exiting the vehicle, the controller causes the speaker to output the phrase, which reminds the passenger in the vehicle to retrieve the item placed on the tray.

5. The support panel adjustment system of claim 2, further comprising:
a vehicle exterior passenger sensor configured to detect a passenger outside the vehicle who intends to enter the vehicle; and
a speaker configured to output a phrase,
wherein the vehicle interior monitoring device further detects whether there is an item on the tray, and
based on it being detected by the vehicle interior monitoring device that there is an item on the tray that the passenger outside the vehicle will have to pass while entering the vehicle, the controller controls the speaker to output the phrase, which reminds the passenger in the vehicle to retrieve the item placed on the tray.

6. The support panel adjustment system of claim 1, wherein the support panel is a footrest,
the footrest is installed on the back side of the seat of the vehicle,
the state of the passenger in the vehicle includes a state in which the passenger in the vehicle has continuously been in the vehicle for equal to or longer than a predetermined period of time or a state in which the passenger in the vehicle is in a fatigue state, and
the controller controls the support panel driving device to rotate the footrest to the unfolded state based on the state of the passenger in the vehicle.

7. The support panel adjustment system of claim 6, further comprising:
a speaker configured to output a phrase,
wherein the vehicle monitoring device further detects whether there are feet on the footrest, and
based on it being detected by the vehicle interior monitoring device that the passenger in the vehicle intends to exit the vehicle and there being feet on the footrest that the passenger in the vehicle passes while exiting the vehicle, the controller causes the speaker to output the phrase which reminds the passenger in the vehicle to remove his or her feet rested on the footrest.

8. The support panel adjustment system of claim 6, further comprising:
a vehicle exterior passenger sensor configured to detect a passenger outside the vehicle who intends to enter the vehicle; and
a speaker configured to output a phrase,
wherein the vehicle monitoring device further detects whether there are feet on the footrest, and
based on it being detected by the vehicle interior monitoring device that there are feet on the footrest that the passenger outside the vehicle will have pass while entering the vehicle, the controller controls the speaker to output the phrase which reminds a passenger in the vehicle to remove his or her feet rested on the footrest.

9. The support panel adjustment system of claim 1, further comprising:
an angle sensor installed in the support panel,
wherein the angle sensor detects an angle formed between a surface of the support panel and a horizontal plane, and
the controller operates the support panel driving device to maintain the angle between the surface of the support panel and the horizontal plane at a predetermined angle.

10. A vehicle, comprising:
a support panel installed on a back side of a backrest of a seat of the vehicle, the support panel adjustment system comprising:
a support panel driving device configured to rotate the support panel so that the support panel is in either an unfolded state or a folded state;
a vehicle interior monitoring device configured to detect a state of a passenger in the vehicle; and
a controller configured to control the support panel driving device to rotate the support panel based on the state of the passenger in the vehicle.

11. The vehicle of claim 10, wherein the support panel is a tray, and
the state of the passenger in the vehicle includes a state in which the passenger in the vehicle is holding an item in his or her hand, a state in which the passenger in the vehicle is not holding an item in his or her hand, a state in which the passenger in the vehicle intends to exit the vehicle, or a state in which the passenger in the vehicle does not intend to exit the vehicle.

12. The vehicle of claim 11, wherein based on it being detected by the vehicle interior monitoring device that the passenger in the vehicle is holding an item in his or her hand, the controller causes the tray located in front of a seat on which the passenger in the vehicle is sitting to be in the unfolded state.

13. The vehicle of claim 10, wherein the support panel is a footrest,
the footrest is installed on the back side of the seat of the vehicle,
the state of the passenger in the vehicle includes a state in which the passenger in the vehicle has continuously been in the vehicle for equal to or longer than a predetermined period of time or a state in which the passenger in the vehicle is in a fatigue state, and
the controller controls the support panel driving device to rotate the footrest to the unfolded state based on the state of the passenger in the vehicle.

14. The vehicle of claim 13, further comprising:
a speaker configured to output a phrase,
wherein the vehicle monitoring device further detects whether there are feet on the footrest, and
based on it being detected by the vehicle interior monitoring device that the passenger in the vehicle intends to exit the vehicle and there being feet on the footrest that the passenger in the vehicle passes while exiting the vehicle, the controller causes the speaker to output the phrase which reminds the passenger in the vehicle to remove his or her feet rested on the footrest.

15. A tray adjustment system, wherein the tray is installed on a back side of a backrest of a seat of a vehicle, the tray adjustment system comprising:
a tray driving device configured to rotate the tray so that the tray is in either an unfolded state or a folded state;
a vehicle interior monitoring device configured to detect a state of a passenger in the vehicle; and
a controller configured to control the tray driving device to rotate the tray based on the state of the passenger in the vehicle.

16. The tray adjustment system of claim 15, wherein the state of the passenger in the vehicle includes a state in which the passenger in the vehicle is holding an item in his or her hand, a state in which the passenger in the vehicle is not holding an item in his or her hand, a state in which the passenger in the vehicle intends to exit the vehicle, or a state in which the passenger in the vehicle does not intend to exit the vehicle.

17. The tray adjustment system of claim 16, wherein based on it being detected by the vehicle interior monitoring device that the passenger in the vehicle is holding an item in his or her hand, the controller causes the tray located in front of a seat on which the passenger in the vehicle is sitting to be in the unfolded state.

18. The tray adjustment system of claim 16, further comprising:
a speaker configured to output a phrase,
wherein the vehicle interior monitoring device further detects whether there is an item on the tray, and
based on it being detected by the vehicle interior monitoring device that the passenger in the vehicle intends to exit the vehicle and there being an item on the tray that the passenger in the vehicle passes while exiting the vehicle, the controller causes the speaker to output the phrase, which reminds the passenger in the vehicle to retrieve the item placed on the tray.

19. The tray adjustment system of claim 16, further comprising:
a vehicle exterior passenger sensor configured to detect a passenger outside the vehicle who intends to enter the vehicle; and
a speaker configured to output a phrase,
wherein the vehicle interior monitoring device further detects whether there is an item on the tray, and
based on it being detected by the vehicle interior monitoring device that there is an item on the tray that the passenger outside the vehicle will have to pass while entering the vehicle, the controller controls the speaker to output the phrase, which reminds the passenger in the vehicle to retrieve the item placed on the tray.

20. The tray adjustment system of claim 15, wherein the tray is installed on a back side of a backrest of a front row seat of the vehicle.
